(19) United States
(12) Patent Application Publication
(10) Pub. No.: US 2023/0369612 A1
(43) Pub. Date: Nov. 16, 2023

(54) MEMBRANE ASSEMBLIES AND SEPARATION LAYERS FOR FUEL CELLS AND ELECTROLYZERS

(71) Applicant: HYDROLITE LTD, Caesarea (IL)

(72) Inventors: Charly David AZRA, Harish (IL); Miles PAGE, Hod Hasharon (IL); Alina AMEL, Binyamina (IL); Ervin TAL-GUTELMACHER, Hod Hasharon (IL)

(73) Assignee: HYDROLITE LTD, Caesarea (IL)

(21) Appl. No.: 18/224,124

(22) Filed: Jul. 20, 2023

Related U.S. Application Data
(63) Continuation-in-part of application No. PCT/IL2021/051524, filed on Dec. 22, 2021.
(60) Provisional application No. 63/140,889, filed on Jan. 24, 2021.

(30) Foreign Application Priority Data
Apr. 19, 2021 (IL) 282438

(51) Int. Cl. H01M 8/0228; H01M 8/1004; C25B 13/07; C25B 13/08

(52) U.S. Cl. CPC H01M 8/0228; H01M 8/1004; C25B 13/07; C25B 13/08

(57) ABSTRACT

Membrane assemblies and separation layer(s) for electrochemical devices such as fuel cells and/or electrolyzers are provided, as well as their production methods. The separation layer(s) include surface-charged particles such as LDH particles to strengthen the membranes, enhance their ionic conductivity and prevent or reduce membrane dehydration and/or chemical degradation. In various configurations a single or few, relatively thick separation layer(s) with surface-charged particles may be used, while in other configurations alternating layers of ionomeric material and layers with surface-charged particles may be used, optimizing ionic conductivity with mechanical strength. Thin protective layers with solids content up to 100% may be set adjacent to the electrodes, and the orientation of the surface-charged particles may be set to enhance the ion conductivity of the respective layer.

### CROSS REFERENCE TO RELATED APPLICATIONS

This Application is a continuation of PCT Application No. PCT/IL2021/051524 filed on Dec. 22, 2021, which claims the priority from U.S. Patent Application No. 63/140,889, filed on Jan. 24, 2021, and Israeli Patent Application No. 282438, filed Apr. 19, 2021, all of which are hereby incorporated by reference in their entirety.

### BACKGROUND OF THE INVENTION

### 1. Technical Field

The present invention relates to the field of electrochemical devices, and more particularly, to membrane assemblies for fuel cells and for electrolyzers.

### 2. Discussion of Related Art

Fuel cells and electrolyzers are electrochemical devices used to generate electricity from fuel (e.g., hydrogen), and to electrolyze water to generate hydrogen (e.g., as fuel), respectively.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a membrane assembly for an electrochemical device, the membrane assembly comprising at least one separation layer that includes surface-charged particles.

One aspect of the present invention provides a method of configuring a membrane assembly for an electrochemical device, the method comprising using in the membrane assembly at least one separation layer that includes surface-charged particles which have a surface excess of charges, imparting ion conductivity along that surface when hydrated.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high-level schematic illustration of devices, according to some embodiments of the invention.

FIGS. 2A-2D are high-level schematic illustrations of membrane assemblies, according to some embodiments of the invention.

FIGS. 2E-2G are high-level schematic illustrations of various orientations of ceramic particles within matrix material of separation layers, according to some embodiments of the invention.

FIGS. 3A and 3B provide a non-limiting example for membrane stability over time, according to some embodiments of the invention.

FIG. 3C provides a non-limiting example for the advantageous decrease in hydrogen crossover for anion exchange membranes protected by a thin layer containing layered double hydroxide (LDH) particles, according to some embodiments of the invention.

FIG. 3D provides a non-limiting example for the relation between the conductivity and the operation temperature of separation layers with high LDH solids content, according to some embodiments of the invention.

FIGS. 3E and 3F provide illustrations of shapes and size distributions of LDH particles used to form separation layers, according to some embodiments of the invention.

FIG. 4 provides low- and high-resolution SEM (scanning electron microscope) images of a cross section of a membrane coated by a protective layer and of the surface of the protective layer, according to some embodiments of the invention.

FIG. 5 is a high-level flowchart illustrating methods, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for preparing and using membrane assemblies and separation layers in fuel cells and in electrolyzers. Membrane assemblies and separation layer(s) for electrochemical devices such as fuel cells and/or electrolyzers are provided, as well as their production methods. The separation layer(s) include surface-charged particles such as LDH particles to strengthen the membranes, enhance their ionic conductivity and prevent or reduce membrane dehydration and/or chemical degradation. In various configurations a single or few, relatively thick separation layer(s) with surface-charged particles may be used, while in other configurations alternating layers of ionomeric material and layers with surface-charged particles may be used, optimizing ionic conductivity with mechanical strength. Thin protective layers with solids content up to 100% may be set adjacent to the electrodes, and the orientation of the surface-charged particles may be set to enhance the ion conductivity of the respective layer.

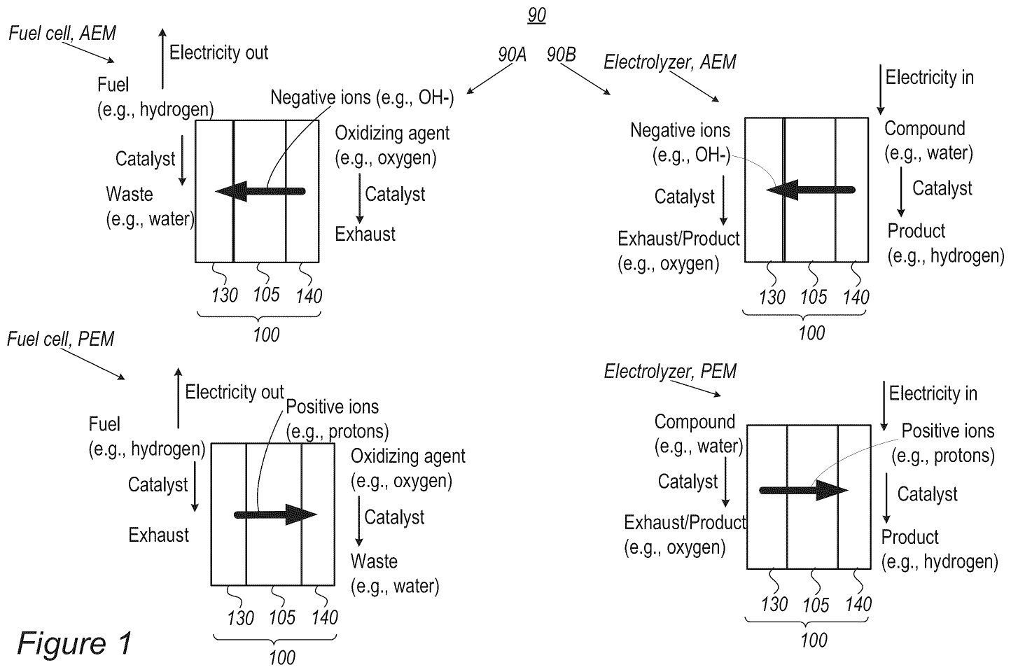

FIG. 1 is a high-level schematic illustration of devices 90, according to some embodiments of the invention. Disclosed membrane assemblies 100 and separation layer(s) 105 may be used for devices 90 such as fuel cells 90A and electrolyzers 90B, for which the principles of operation are briefly described. As non-limiting examples, implementations fuel cells 90A and electrolyzers 90B with AEM (anion exchange membranes) and PEM (proton exchange membranes) are illustrated in a highly schematic manner. Devices 90 typically have anodes 130 and cathodes 140 with corresponding catalysts that catalyze the respective reactions, as described briefly herein.

Fuel cells 90A are electrochemical cells that generate electricity (denoted schematically as “electricity out”) using a fuel (e.g., hydrogen) and an oxidizing agent (e.g., oxygen). In the case of hydrogen AEM fuel cells 90A, the hydrogen fuel is oxidized by hydroxide (OH⁻) anions formed at cathode side 140 from a reaction of water with oxygen, and moving through separation layers 105 to anode side 130, releasing electrons that travel through an external circuit to the cathode, thereby providing electrical power, as well as product water. In hydrogen PEM fuel cells 90A, the hydrogen is oxidized at anode side 130, releasing electrons that travel through an external circuit to the cathode, thereby providing electrical power, and protons which move through separation layers 105 to cathode side 140 where they combine with oxygen to form product water.

Electrolyzers 90B are electrochemical cells that use electricity (denoted schematically as “electricity in”) to break down compounds (e.g., water) to yield products (e.g., hydrogen or other compounds). In AEM water electrolyzers 90B (including ones working with alkaline water, e.g., water with KOH), electricity is used to break down water to form hydrogen gas at cathode side 140, as well as hydroxide (OH⁻) anions that move through separation layers 105 to anode side 130, where they are reacted to form oxygen and water. In PEM electrolyzers 90B, water is broken down at anode side 130 to yield oxygen gas and cations (e.g., protons) that move through separation layers 105 to form hydrogen gas at cathode side 140.

Electrolyzers 90B are typically used to generate hydrogen for storage a future use, e.g., in fuel cells 90A. Often, similar technologies are used for fuel cells 90A and electrolyzers 90B, with varying specifications of the respective components to optimize the respective device. Certain devices 90 may be configured to operate as reversible fuel cells, namely devices 90 may be operated alternatively, or alternately, as fuel cells 90A and electrolyzers 90B. Devices 90 may comprise any type of fuel cell 90A or electrolyzer 90B, including non-hydrogen fuel cell 90A or non-hydrogen electrolyzer 90B. Moreover, devices 90 may comprise other types of electrochemical synthesizers, such as chlor-alkali plants for the electrolysis of sodium chloride solutions, electrochemical synthesis of hydrogen peroxide (H₂O₂), etc., which may comprise disclosed membrane assemblies 100 and separation layer(s) 105 as well. Unless stated otherwise, disclosed membrane assemblies 100 and separation layer(s) 105 may be used in either type of device 90, by adjusting the implementation details such as dimensions (especially thickness), materials and internal structure, as disclosed herein.

Fuel cells 90A and/or electrolyzers 90B may further comprise gas diffusion layers (GDLs) that allow gases and/or fluids through. Membrane assemblies 100 may comprise separation layer(s) 105, optionally one or both anode(s) 130 and cathode(s) 140 and optionally also corresponding gas diffusion layers. For example, membrane assemblies 100 may be configured to operate as membrane-electrode assemblies (MEAs) that are the core components of proton-exchange membrane fuel cells (PEMFCs) and proton-exchange membrane electrolyzers (PEMELs); as well as of anion-exchange membrane fuel cells (AEMFCs) and anion-exchange membrane electrolyzers (AEMELs). Membrane assemblies 100 may be manufactured separately from the electrodes, or one or even both electrodes 130, 140 may be deposited on membrane assembly 100 itself, forming respective catalyst-coated membranes (CCM). Alternatively or complementarily, the catalyst layers may be deposited on gas-diffusion layers (GDLs), forming gas diffusion electrodes (GDEs) that are pressed against membrane assembly 100 to form the respective stacks.

Separation layer(s) 105 may comprise one or more sheet(s) that may range in thickness from a few μm, through tens of μm and up to one or two hundred μm. Separation layer(s) 105 may comprise multiple thin sheets, some thin and some thicker sheets, or any operable combination of number and thickness of the sheets, reaching an overall thickness of up to 200 μm. The sheets of separation layer(s) 105 may be configured to combine high ionic conductivity, water transportability, mechanical strength and stability, and low gas permeation, and be optimized respectively as disclosed herein. For example, one or more sheets of separation layer(s) 105 may be configured to support other, main separation sheet(s) of separation layer(s) 105. The supporting sheets in separation layer(s) 105 may be very thin, e.g., hundreds of nanometers thick, tens of nm thick or even 10 nm, 5 nm or less in thickness, possibly down to the thickness of ceramic particles embedded therein themselves.

In various embodiments, separation layer(s) 105 may comprise ionomer membranes, membranes that incorporate ionic particles, and/or stabilizing structures such as mesh supports or particles, which may also limit membrane swelling upon water uptake. The thickness and order of multiple separation layers 105 may be configured to optimize the parameters required for each type of device 90 and respective performance requirements. Membrane assemblies 100 may include several functional separation layers 105, and may be manufactured in different ways, e.g., by multi-layer deposition upon any substrate (including e.g., GDL(s), GDE(s), catalyst layers as CCMs, etc.) or by attaching of multiple supported and/or unsupported layers of separation layer(s) 105, as disclosed herein.

Separation layer(s) 105 are configured to provide a gas-tight separation between electrodes 130, 140 and to conduct ions and transfer water between electrodes 130, 140. Separation layer(s) 105 are configured to have high ionic conductivity to limit ohmic losses and device dry-out, e.g., by using high quality ionomers and/or by decreasing membrane thickness—either by reaching the limit for ultra-thin freestanding membranes or by using membranes supported by meshes, which however reduce the amount of available ionomer, yielding a tradeoff between the components contributing to ionic conductivity. Disclosed separation layer(s) 105 and membrane assemblies 100 are characterized by a combination of high ionic conductivity and mechanical strength, in some embodiments utilizing the properties of layered double hydroxides (LDHs), which are ionic solids having a layered structure that includes layers of metal cations and layers of hydroxide OH− anions; and are capable of conducting ions along the layers.

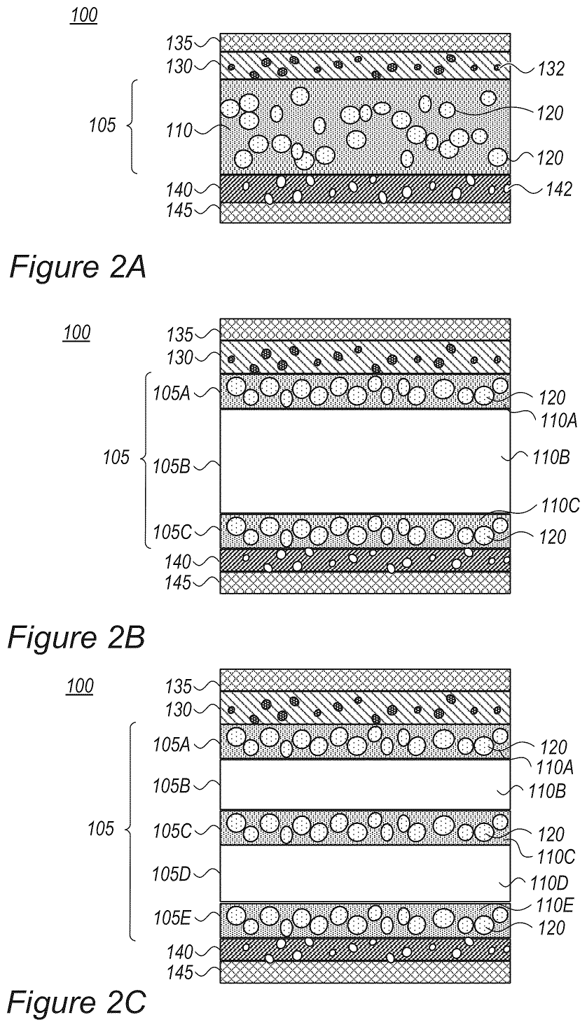

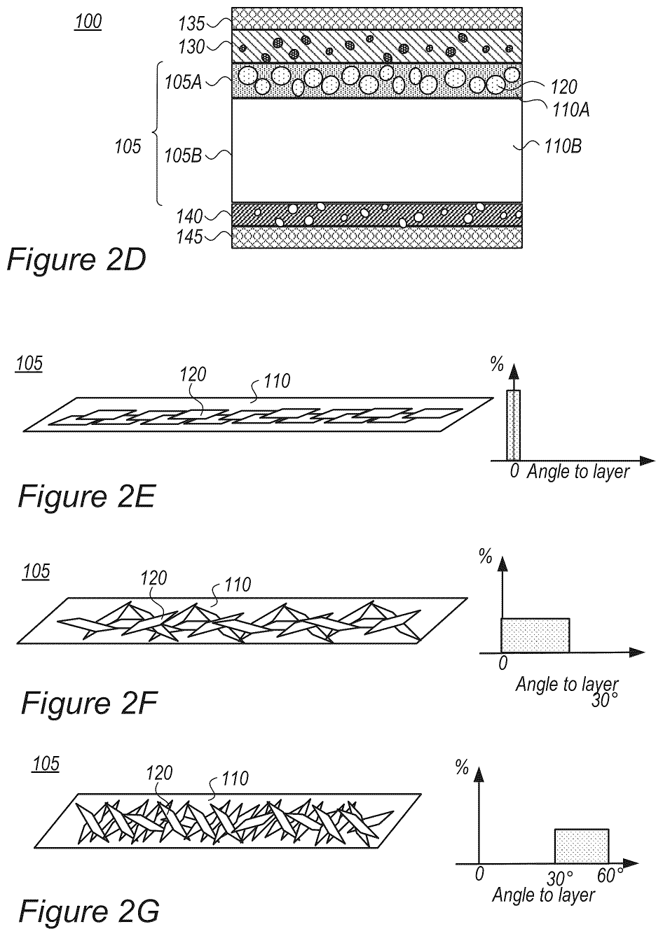

FIGS. 2A-2D are high-level schematic illustrations of membrane assemblies 100, according to some embodiments of the invention. Membrane assemblies 100 may comprise multiple layers illustrated in non-limiting examples; the layers may be combined in any operable combination and the illustrations merely serve an explanatory purpose. Membrane assemblies 100 may comprise anode catalyst layer(s) 130, optionally with respective gas diffusion layer(s) (GDLs) 135 and cathode catalyst layer 140, optionally with respective gas diffusion layer(s) (GDLs) 145. Membrane assemblies 100 may be configured to operate in any type of device 90, e.g., fuel cells 90A, electrolyzers 90B and/or electrochemical synthesizers, as well as in solid-state batteries.

Membrane assemblies 100 may comprise one or more separation layer(s) 105 that separate anode catalyst layer(s) 130 from cathode catalyst layer 140 and are typically configured to allow ions (e.g., protons or hydroxide ions) to pass through it to enable proper operation of respective device 90. One or more of separation layer(s) 105 may be composite comprising a matrix 110 with embedded particles 120. It is noted that other one or more of separation layer(s) 105 may comprise only matrix 110 which may be the same, similar, or different from matrix 110 in composite separation layer(s) 105. For example, some of separation layer(s) 105 may comprise polymer layers with embedded particles 120 and other separation layer(s) 105 may comprise polymer layers only. As illustrated schematically in FIGS. 2A-2D, separation layer(s) 105 may comprise multiple layers, e.g., 105A, 105B, 105C, 105D, 105E, some of which may be similar and others different from each other, and layers 105 may be made of different or similar materials indicated schematically by corresponding matrix types 110A, 110B, 110C, 110D, 110E, some may be made of similar materials and other of different materials; some of which may include particles 120 (similar or different among layers) and others not—as disclosed herein.

In various embodiments, separation layer 105 may have a thickness of any of 200 μm, 100 μm or less, e.g., any of 50 μm, 30 μm, 20 μm, 10 μm, 5 μm or less, or intermediate values. Specifically, in fuel cell applications, separation layer 105 may be less than 30 μm or less than 50 μm, while in electrolyzers separation layer 105 may be thicker, up to 100 μm or even 200 μm thick. In certain embodiments, layers 105A, 105C and 105E, being layers within or adjacent to the main separator layers (e.g., layers 105B, 105D) rather than complete separators by themselves, may be as thin as the thickness of the surface-charged particles (e.g., charged ceramic particles) themselves, e.g., in the range of 5 nm or less.

In non-limiting examples, FIG. 2A illustrates schematically separation layer 105 that is made of polymer matrix 110 and ion-conductive particles 120, and is relatively thick (e.g., tens of μm, and up to 100-200 μm). Polymer matrix 110 may comprise ionomer(s) and have high ion conductivity (e.g., between 10 mS/cm and more than 100 mS/cm, or any intermediate values), while particles 120 may be used to improve mechanical properties, (for example, yield stress, strain at break, resistance to creep, or other desirable properties, as can be measured comparatively with equivalent polymer without ceramic additives) and possibly the ion conductivity of separation layer 105. Alternatively or complementarily, polymer matrix 110 may have low ionic conductivity and include a high solid content (e.g., over 60%, 70%, 80%, 85%, 90% or more by weight) of ion-conductive particles 120.

In non-limiting examples, FIG. 2B illustrates schematically separation layer 105 that is made of layer 105B of polymer matrix 110B that is typically thick and ion conductive (e.g., >20 mS/cm, e.g., made of ionomer) and may be from about 5 μm thick, and up to 100-200 μm thick, and thin layers 105A, 105C of polymer matrix 110A, 110C respectively, with particles 120 embedded therein. Particles 120 may be the same or different particles and may have the same or different concentrations and parameters in either layer 105A, 105C. For example, in different implementations, layers 105A, 105C may comprise any of a range of different concentrations, ranging e.g., from a few weight % of ceramic particles 120 and possibly up to 100 weight % ceramic of ceramic particles 120. At higher concentrations, ceramic particles 120 may be deposited as a thin layer using a solvent that may be removed, e.g., by evaporation, leaving very thin layers 105A, 105C of ceramic particles 120 that may be as thin as ceramic particles 120 themselves or close thereto, possibly hundreds, tens or even several nanometers thick. In certain embodiments, layers 105A, 105C may be few to tens of μm thick, and be configured to mechanically support layer 105B, possibly resist gas crossover and prevent drying and consequent membrane degradation at the edges of layer 105B. Any of matrices 110A, 110C may be made of ion conductive material with particles 120 that are ion-conductive or not, or any of matrices 110A, 110C may be made of polymer material with ion-conductive particles 120 to enhance ion conductivity over the thin layer of polymer material. It is noted that layers 105A, 105C may be made thin to minimize the reduction in ionic conductivity they cause while maintaining their mechanical strength. In various embodiments, layers 105A, 105C may even be configured to be porous, as the main gas barrier is provided by thicker intermediate layer 105B.

In non-limiting examples, FIG. 2C illustrates schematically separation layer 105 that is made of two or more polymer layers 105B, 105D which may be ionomeric and have high ion conductivity, with three or more thinner composite layers 105A, 105C, 105E configured to strengthen separation layer 105 mechanically and protect the edges of polymer layers 105B, 105D from dehydration and/or chemical degradation by exposure to dry gases and/or catalytically active materials.

It is noted that such protection is beneficial due to the tendency of the electrode layers 130, 140 to remove water (depending on the device configuration) and dehydrate adjacent polymer membranes leading to reduced ionic conductivity. Using layers 105A and/or 105E to provide the respective interface to electrode layers 130, 140 may protect the ionomeric membrane. Layers 105A, 105E may correspondingly have high solid content, e.g., of ion-conductive particles 120, and may comprise matrix 110A, 110E which is not necessarily ion conductive, as it can be made very thin (potentially as low as <5 nm).

Intermediate layer 105C with surface-charged particles 120 such as charged ceramic particles 120 may be configured to enhance the mechanical strength and stability of the stack of separation layers 105 while maintaining the ionic conductivity of separation layer 105. In non-limiting examples, layers 105B, 105D may mainly comprise ionomer matrix 110B, 110D and be up to 20 μm thick, while intermediate layer 105C may comprise medium to high solid content of particles 120 in matrix 110C, which may be at least partly ionomeric. Intermediate layer 105C may be up to 10 μm thick, up to 5 μm thick, or even thinner.

In various embodiments, any of layers 105A, 105C, 105E may even be porous, as the main gas barriers are the thicker intermediate layers 105B, 105D. It is noted that the properties of separation layer(s) 105 such as ion conductivity and thickness may be selected to provide overall sufficient ion conductance over the full stack, which is sufficiently blocking gas and liquid crossover. For example, separation layer(s) 105 may be configured to have a total area-specific resistance (ASR) that is smaller than 200 Ohm·cm², smaller than 100 Ohm·cm², smaller than 50 Ohm·cm², or having intermediate ASR values. Separation layer(s) 105 may be configured to have these ASR values while keeping their area-specific hydrogen permeation values smaller than about 10⁻⁷ mol/s/m²/Pa for fuel cells 90A, and smaller than about 10⁻⁸ mol/s/m²/Pa or even lower for electrolyzers 90B, depending on the desired degree of hydrogen pressurization.

In non-limiting examples, FIG. 2D illustrates schematically separation layer 105 that is made of thin layer 105A on one side only of thicker layer 105B, to provide protection, e.g., from dehydration of layer 105B and/or from catalytic degradation of layer 105B by buffering, mechanically, its contact with the catalyst layer on anode 130. Layer 105A may have any of the properties discussed herein, e.g., be very thin (possibly less than 1 μm, possibly mostly composed of ceramic particles 120 and even possibly porous), while layer 105B may provide the main separation membrane, as discussed herein as well. Protective layer 105A may be applied on one side only of main membrane 105B in any of the embodiments disclosed herein, e.g., near water-consuming electrodes (e.g., cathode 140 in AEM fuel cells 90A and AEM electrolyzers 90B) or near high electrical potential electrodes (e.g., cathode 140 in PEM fuel cells 90A, and/or near anode 130 in AEM and PEM electrolyzers 90B). Accordingly, certain embodiments comprise one-sided thin layer 105A adjacent to cathode 140, used in an equivalent way to that described above for anode 130, or thin layers adjacent to both anode 130 and cathode 140, as illustrated, e.g., in FIGS. 2B and 2C.

Component layers of separation layer(s) 105 may be selected to have specific characteristics relating to their order in the stack and the functioning of device 90. The layers may be selected from: (i) ionomeric layer (e.g., layer 105B), (ii) ionomeric layer with particles for added strength, (iii) ionomeric layer with ion-conductive particles for added strength and enhanced ion conductivity (e.g., layer 105C), (iv) passive or even porous polymer layer with high concentration of ion-conductive particles for added strength and ion conductivity, as well as protection against dehydration of ionomeric layers (e.g., layers 105A, 105E), (v) thin passive polymer layer with low concentration of ion-conductive particles for added ion conductivity, and so forth, for any required combination of features.

Separation layer(s) 105 may be produced in a range of ways, including attachment of free membrane layers, deposition of consecutive layers on a substrate (e.g., electrodes 130, 140 and/or GDLs 135, 145) and/or combinations thereof. Formation of individual layers may be carried out by polymerization of respective monomers (and/or oligomers), including or followed by any of cross-linking polymer chains, functionalization into ionomers if needed and/or mixture of particles that are ion-conductive or not, into any of the fluid precursor(s) prior to polymerization. Individual layers may then be attached to form separation layer 105 and/or consecutive layers 105 may deposited onto respective substrates, followed by drying (or optionally peeling in case of using a sacrificial substrate).

In certain embodiments, composite separation layer(s) 105 may comprise anion conducting ionomer(s) as matrix 110 for anion-exchange membrane (AEM) devices 90 (fuel cells 90A or electrolysis-based devices 90B) or cation conducting ionomer(s) as matrix 110 for proton-exchange membrane (PEM) devices 90 (fuel cells 90A or electrolysis-based devices 90B). Particles 120 when present may be chemically inactive and/or ion-conducting particles that may be used to facilitate ion conduction separation layer(s) 105, depending on implementation.

In non-limiting examples, matrix 110 may comprise a continuous anion conducting ionomer (for AEM implementations) comprising, e.g., polymers or copolymers of (vinylbenzyl)trimethylammonium chloride, wherein the chloride counterion may be exchanged to any desired anion, copolymers of diallyldimethylammonium chloride (DADMAC), wherein the counterion may be exchanged to any desired anion, styrene-based polymers having quaternary ammonium anion conducting group, quaternized poly(vinylalcohol) (QPVA), bi-phenyl or tri-phenyl backboned polymers with one or more functional groups that could include alkyl tether group(s) and/or alkyl halide group(s) and/or equivalent groups, poly(arylpiperidinium) and other polymers containing cyclic quaternary ammonium in the backbone or on tethered sidechains, poly(bis-arylimidazoliums), cation-functionalized poly(norbornenes), neutral polymers or polymer membranes with grafted anion-conductive sidechains, or any other anion-conducting polymer. In some embodiments, the anion conducting ionomer may be crosslinked, e.g., using crosslinking agent(s) selected according to the type of the ionomer to be crosslinked, such as divinylbenzne, N,N,N′,N′-tetramethyl-1,6-hexanediamine (TMHDA), 1,4-diazabicyclo[2.2.2]octane (DABCO), glyoxal, glutaraldehyde, styrene based polymer(s) having quaternary ammonium anion conducting group(s), bi-phenyl or tri-phenyl backboned with one or more functional groups that could include alkene tether group(s) and/or alkyl halide group(s) and/or equivalent groups, hydrocarbon chains, sulfur groups, siloxy groups, N-hydroxybenzotriazole groups, azide groups and the like. In some embodiments, the anion conducting ionomer may be a blend of several polymers, some of which may not be anion conducting.

In non-limiting examples, matrix 110 may comprise a continuous cation conducting ionomer (for PEM implementations) comprising, e.g., poly(aryl sulfones), perfluorinated polysulfonic acids such as Nation®, polymers or copolymers of styrene sulfonic acid with various modifications, sulfonated polyimides, phosphoric acid-doped poly(benzimidazole), sulfonated poly(arylene ethers) such as sulfonated poly (ether ether ketone) (SPEEK) and/or other synthetic or natural cation exchange ionomers.

In some embodiments particles 120 may be surface-charged and ion-conducting in hydrated media by means of excess surface charge. For example, nanoparticles 120 may comprise nanoparticles of any of LDH (as ion-conductive particles 120), bentonite, montmorillonite, laponite, smectite, halloysite, cloisite, hydrotalcite (as non-limiting examples for charged clay particles 120), zirconium oxide, titanium oxide (as non-limiting examples for surface charged non-clay ceramic particles 120), graphene oxide, reduced or partially reduced graphene oxide, boron nitride, functionalized polyethylene, polytetrafluoroethylene, poly(ethylene tetrafluoroethylene) or other polymer nanoparticles, or their combinations, configured as surface charged particles 120.

In non-limiting examples, nanoparticles 120 may include any type of chemically inactive nanoparticles that do not react chemically or electrochemically with the anions or cations conducted through separation layer(s) 105 and with chemical reactions taking place in the respective membrane assembly 100 and/or respective fuel cell(s) 90A and/or electrolyzers(s) 90B. It is noted that particles 120 may only be ion conducting to some extent, and not interact chemically in any other way. In some embodiments, chemically inactive nanoparticles 120 may be configured to reinforce ionomer matrix 110 and increase its mechanical strength. In some embodiments, the amount of chemically inactive nanoparticles maybe at least any of 1, 2, 5 or 10 weight %, or intermediate values for layers with low solid content, 20-50 weight % or intermediate values for layers with medium solid content, or 50-90 weight % or even up to 100 weight %, or intermediate values, for layers with high solid content—used in dependence of the layer thickness and function with the stack, as explained herein.

In various embodiments, at least some of separation layer(s) 105 may comprise both chemically inactive nanoparticles and chemically active particles as particles 120. In various embodiments, at least some of separation layer(s) 105 may comprise both surface-charged particles and uncharged particles as particles 120.

In various embodiments, separation layer 105 may be configured to comprise a combination of (i) ion-conductive clay nanoparticles 120 (e.g., charged ceramic particles or other surface-charged particles) comprising a high solid component (e.g., 70-100% weight % of particles) combined with (ii) neutral, stable polymer (e.g., as matrix 110) to form a high-temperature stable composite separation layer 105 (e.g., as illustrated in FIG. 2A), and/or layers 105B and/or 105D (e.g., as illustrated in FIGS. 2B and 2C).

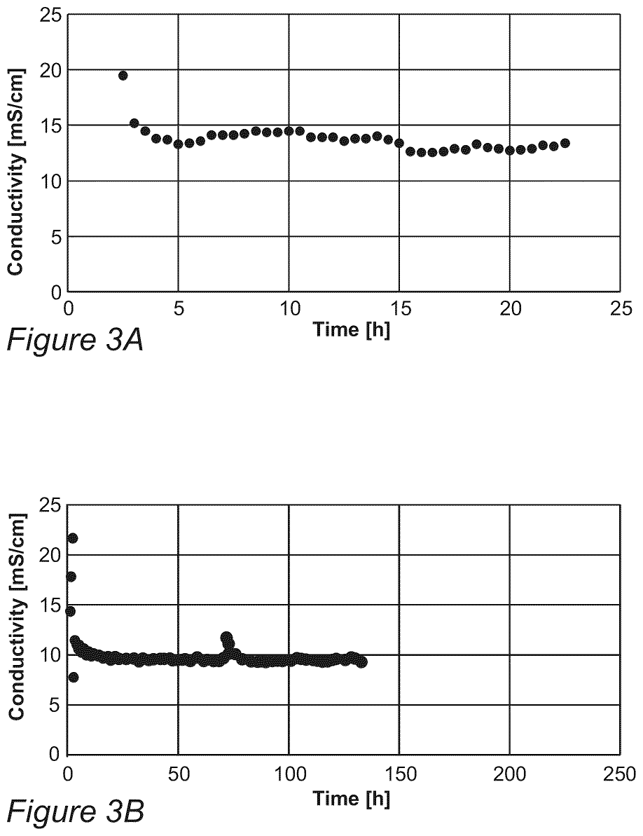

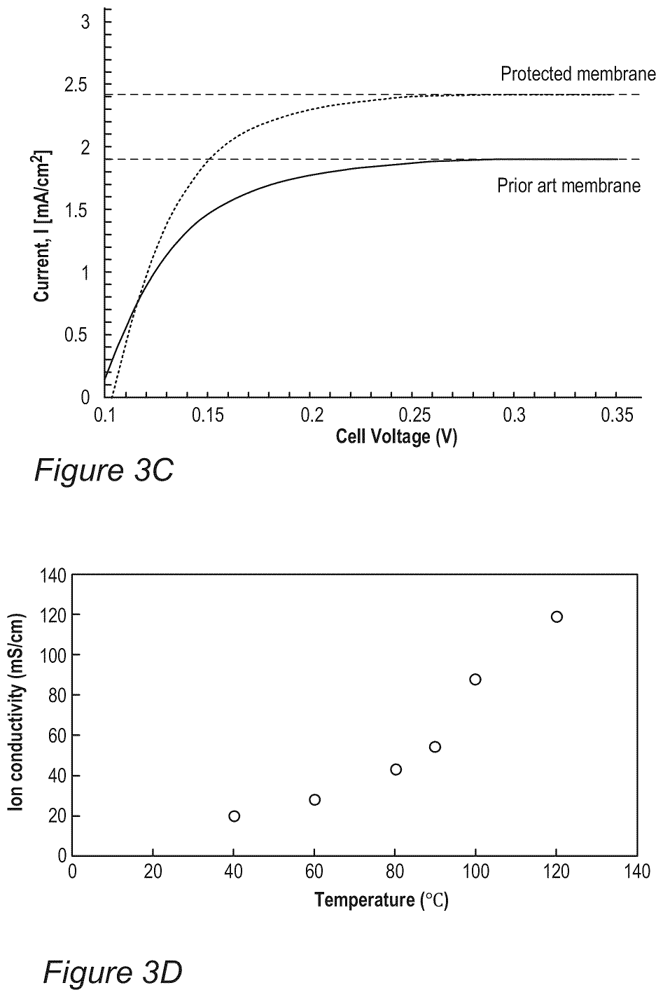

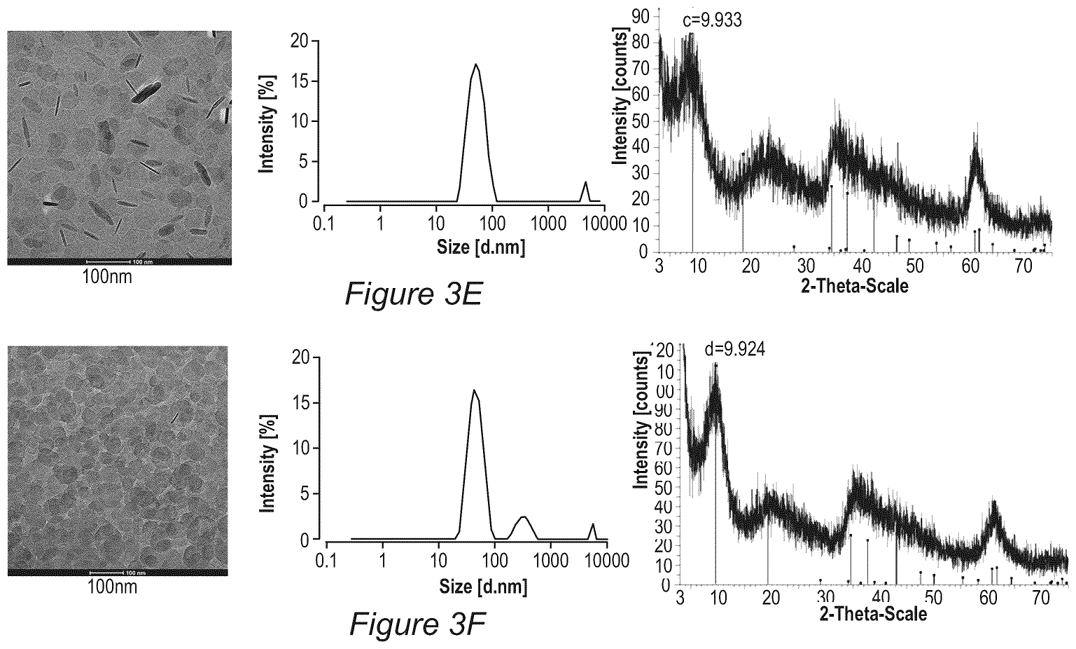

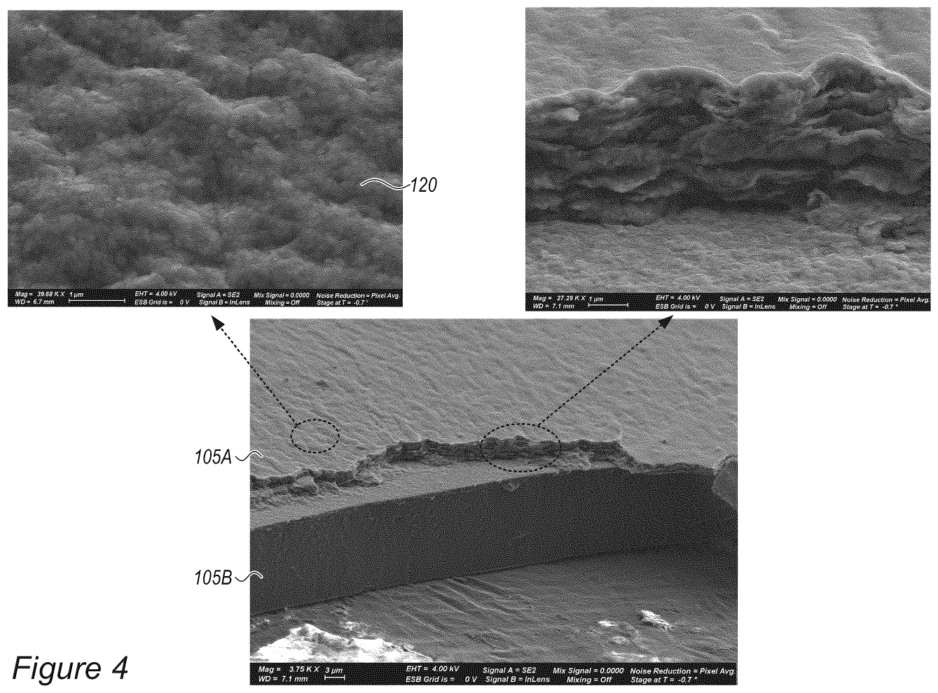

In various embodiments, protective layer 105A, 105C and/or 105E may be formed on the surface of matrix 110 and/or on separation layer 105B and/or 105D to enhance stability, durability, strength or reduce gas crossover, with any combination of low, medium or high solids content (see, e.g., the experimental results presented in FIG. 3C and the SEM image in FIG. 4), being a porous or non-porous layer, and using ion-conducting or non-conducting solid particles and polymer binder. Protective layer 105A, 105C and/or 105E may be configured to allow sufficient ion conductance and water permeation, by adjusting the thickness of protective layer 105A, 105C and/or 105E within a range between a few nanometers to a few microns, or up to about ten microns, or according to the requirements of the specific application.

Protective layer 105A (and/or 105C as in FIG. 2B, (and/or 105E as in FIG. 2C) on one or both sides of separation layer 105 that face electrodes 130, 140, may be made very thin and therefore not necessarily ion conductive. For example, the protective layers may have high ion conductivity (e.g., >10 mS/cm), medium ion conductivity (e.g., 1-10 mS/cm), low ion conductivity (e.g., 0.01-1 mS/cm), or even no ion conductivity (e.g., <0.01 mS/cm), the latter, e.g., if the protective layer is not fully continuous, or porous, so that ions can pass through gaps or pores therein while the protective layer prevents dehydration of ionomer matrix 110B (e.g., the protective layer may have an ion-conductivity that is smaller than 0.01 mS/cm at its continuous or non-porous parts, respectively).

Particles 120 may be ion conducting and be monodisperse in size to encourage ordered stacking within respective matrix 110 or layer 105, to maximize its strength and gas separation, or particles 120 may be polydisperse and/or mixed with filler (inactive) particles to encourage disorder within respective matrix 110 or layer 105, thereby maintaining higher ion conductivity of respective layer 105.

For example, montmorillonite, laponite, bentonite, smectite and/or equivalent particle types may be used as particles 120 to contribute to cation exchange due to their negative excess surface charges. Particles 120 may be dispersed in layer 105 in a way that allows the charged surfaces to interact with each other and modify the mechanical and permeation properties of surrounding polymer matrix 110. It is noted that respective layer 105 may be configured to have sufficient ion conductance by thinning layers 105 with high weight % of particles 120. When multiple separation layers 105 are used as a stack, the overall ion conductance may be assured by the corresponding combination of thin layers 105 with high concentration of particles 120 and thicker layers 105 with lower concentration of particles 120 or no particles 120 within ionomer matrix 110.

Hydrotalcite and other layered-double hydroxides (LDH) may be used as particles 120 with relatively high and partially tunable positive surface charge density. Because of the high density, LDH particles 120 may be configured to have relatively high anion conductivity and in certain embodiments be used as independent ion conductor layer 105. Because of the plate-like structure with a very thin z-axis, exfoliated hydrotalcite particles 120 may be used to achieve very high conductivities (many tens of mS/cm to over 100 mS/cm) with a high solids content, possibly in a neutral (non-ion-conducting) matrix 110.

Alternatively or complementarily, LDH particles 120 may be used in conjunction with anion-conducting matrix 110 as additive(s) with a low or medium level of solids content—to improve the properties of respective layer 105 for use in electrochemical devices 90 such as exchange membrane fuel cells 90A and electrolyzers 90B.

Neutral (inactive) inorganic particles 120 may comprise particles of reduced graphene oxide, graphene oxide, zirconium oxide, titanium oxide, polytetrafluoroethylene nanoparticles, boron nitride or their alloys or combinations. Neutral (inactive) inorganic particles 120 may be used in conjunction with ion-conducting polymer matrix 110.

Concerning the production methods, consecutive deposition of layers 105 may be carried out, e.g., by any of spraying, electrospray coating, slot die casting, doctor blading, screen printing, inkjet printing, 3D printing, or combinations thereof and/or equivalent methods. The liquid matrix may include monomers that may include functional groups for forming the ionomer (functionalized monomers). Some examples of functional monomers comprise (vinylbenzyl)trimethylammonium chloride and/or DADMAC, as disclosed above. The liquid matrix may include non-functional co-monomers such as any of styrene, divinyl benzene, isoprene, butadiene, acrylamide, combinations thereof and/or equivalent monomers. In certain embodiments, the liquid matrix may include polymerized and/or partly polymerized polymer chains with or without functional groups such as poly(vinyl benzyl chloride) and/or its copolymers, poly(vinylbenzyl)trimethylammonium chloride and/or its copolymers, poly(diallyldimethyl ammonium chloride), poly(vinyl alcohol) combinations thereof and/or equivalent oligomers and/or polymers. The liquid matrix may include particles 120 (e.g., as listed above). In some embodiments, deposited monomers, oligomers and/or polymers may be functionalized after deposition of separation layer 105, e.g., by transforming a non-functional group to a functional group (e.g., transforming chloromethylated group(s) to trimethylammonium group(s). Functionalization may be followed by adding, e.g., trimethylamine (TMA) to initiate quaternization reaction(s).

In various embodiments, the dispersion may be deposited on any suitable substrate and/or into any suitable mold for forming separation layer 105 and/or membrane assembly 100 or part(s) thereof. The substrate may be a solid flat surface, made, e.g., of any of glass, ceramic, plastic, metal or combinations thereof, and used to produce a self-supported membrane as separation layer 105. In some embodiments, the self-supported membrane may be further coated with anode catalyst layer 130 and/or with cathode catalyst layer 140 to form catalyst coated membrane(s) (CCMs). In some embodiments, the dispersion may be deposited on anode-side gas diffusion layer(s) (GDLs) 135 and/or on cathode-side gas diffusion layer(s) (GDLs) 145. It is noted that GDLs with the respective catalysts are typically considered gas diffusion electrode(s) (GDEs). Consequently, throughout the description, GDEs may be used for respective combinations of GDLs and catalysts, e.g., anode side GDE may comprise anode catalyst layer 130 and GDL 135, while cathode side GDE may comprise cathode catalyst layer 140 and GDL 145.

In various embodiments, the deposited dispersion may be hardened to form the stable membrane, e.g., by drying and/or curing the deposited membrane, crosslinking the monomers, oligomers and/or polymers in the deposited dispersion, etc. In some embodiments, the polymers in the thin membrane may be crosslinked using any suitable crosslinking agent, e.g., divinylbenzne, N,N,N′,N′-Tetramethyl-1,6-hexanediamine (TMHDA), 1,4-diazabicyclo[2.2.2]octane (DABCO), glyoxal, glutarhaldehyde, etc., e.g., selected according to the type of the ionomer that is to be crosslinked.

The thickness of deposited matrix 110 may be any of 200 μm, 100 μm or less, e.g., any of 50 μm, 30 μm, 20 μm, 10 μm, 5 μm or less, or intermediate values. Specifically, in fuel cell applications, deposited matrix 110 may be less than 50 μm or even less than 30 μm, 20 μm or 10 μm (depending on the layer structure of separation layer 105, as disclosed herein) while in electrolyzers deposited matrix 110 may be thicker, up to 100 μm or even 200 μm thick, or have intermediate values.

In certain embodiments, composite separation layer(s) 105 may comprise matrix 110 that has no or low ion conductivity and ion conductive particles 120 such as layered double hydroxide (LDH) particles, which are charged ceramic particles, with known high charge density, capable of conducting anions. Other possible cationic clays or “solid bases” could also be substituted according to the application and their surface charge density. In non-limiting examples, matrix 110 may comprise neutral polymer(s) such as polybenzimidazole (PBI), poly vinyl alcohol (PVA), poly(ethylene-co-vinyl alcohol) EVOH or combination thereof. Chemically active particles 120 may comprise particles and/or nanoparticles that are anion conducting such as LDH particles that may be in contact or near-contact with each other and form anion conducting path(s) throughout separation layer(s) 105. In some embodiments, pre-synthesized LDH particles may be mixed with polymer precursor(s) for polymer that allow water to penetrate matrix 110 (e.g., PBI, PVA and/or EVOH)—to form separation layer(s) 105. In some embodiments, pre-synthesized LDH particles may be mixed with corresponding monomers and/or oligomers (e.g., of PBI, PVA and/or EVOH) to be polymerized to form neutral matrix 110. In some embodiments, the LDH particles may be synthesized inside a mixture of pre-synthesized polymer.

FIGS. 2E-2G are high-level schematic illustrations of various orientation distributions of ceramic particles 120 within matrix material 110 of separation layers 105, according to some embodiments of the invention. In various embodiments, surface-charged particles and/or charged ceramic particles 120 may be flat particles (e.g., particles of layered materials such as solids with highly anisotropic bonding, see, e.g., FIG. 4), and their orientation within separation layer 105 may be configured to enhance ion conductivity of layer 105. It is noted that layers 105 illustrated in FIGS. 2E-2G may refer to any of layers 105A-E in any of the configurations of separation layer(s) 105 disclosed herein.

In certain embodiments, e.g., as illustrated schematically in FIG. 2E, ceramic particles 120 (or other surface-charged particles) may be arranged horizontally, e.g., to minimize layer thickness, to increase the solids content and/or as to provide thin layer protection of a main separation layer, as described herein. Deposition of horizontal particles 120 may be carried out using an evaporating solvent that lets the particles platelets settle horizontally upon the substrate on which they are deposited.

In certain embodiments, e.g., as illustrated schematically in FIG. 2F, ceramic particles 120 (or other surface-charged particles) may be arranged at a range of relatively small angles, e.g., between horizontal orientations and angles of 10°, 20°, 30°, 40°, or intermediate values of angles to the layer surface, e.g., to increase ion conductivity with respect to purely horizontal orientation of particles 120 and/or to increase the solids contents (with respect to a layer with purely disordered orientation of the particles) within thicker layer 105. Deposition of particles 120 at specified angle distributions may be carried out using intermixed inactive or active particles (not shown), linking among particles 120 and/or particles 120 having different sizes or shapes.

In certain embodiments, e.g., as illustrated schematically in FIG. 2G, ceramic particles 120 (or other surface-charged particles) may be arranged at a range of relatively large angles to the surface of layer 105, e.g., between angles of 10°, 20°, 30°, 40°, or intermediate values and up to 50°, 60°, 70°, 80° or even 90° (particles 120 vertical to layer 105), or intermediate values, e.g., to further increase ion conductivity and/or to further increase the solids contents of layer 105. Deposition of particles 120 at specified angle distributions may be carried out using intermixed inactive or active particles (not shown), linking among particles 120 and/or particles 120 having different sizes or shapes. Moreover, in any of the embodiments, orientation forces (e.g., mechanical, magnetic, electrical, cohesive or other forces or various dispersion configurations) may be applied to modify and/or control the orientation of particles 120. In certain embodiments, particles orientation may be even closer to vertical, e.g., between 60-90°, 70-90°, 80-90° or intermediate values.

Different separation layers 105 (or sheets thereof) may have particles 120 at different orientations, or combinations of particles orientations as illustrated schematically in FIGS. 2E-2G may be implemented in single layer 105.

In embodiments of surface-charged particles and/or charged ceramic particles 120 made of layered materials, the layers may be exfoliated to form particles 120 and/or intercalated with specified molecules or ions to enhance their surface charge. For example, a substantial portion of particles 120 may have gaps between their layers that are occupied with corresponding ions and/or matrix material. For example, in case of LDH, LDH particles 120 may be at least partly exfoliated, having separated layers with gaps occupied by counterions and matrix material. The degree of exfoliation may result in platelet-like particles 120 that have a thickness defined by a few repeats of the crystal lattice, e.g., a few nm or a few tens of nm, and platelet dimensions ranging between tens of nm to a few microns in length and width. The dispersion properties of particles 120 may vary with the type of matrix 110, and may be disordered in low to medium solids content layers 105, and substantially ordered and intercalated by polymer matrix 110 in the high solids content layers 105.

In certain embodiments, non-horizontal particles 120 (see, e.g., FIGS. 2F and 2G) may be configured to enhance through-plane ion conductivity, in a direction vertical to layer 105. Ion conductivity may be increased by ion conduction across a composite containing charged ceramic particles 120 (or other surface-charged particles 120) by way of ion transport along the surface(s) of particles 120 that contain most of the surface excess of electronic charge. For example, end to end contact or at least proximity between particles 120 may enable ions to move from one particle to the next across layer 105, increasing its ion conductivity. Orientation, or at least partial orientation of particles 120 across layer 105 may be implemented by direct control of particle orientation—e.g., via the deposition process or applied external forces; and/or by indirect control of particles orientation—e.g., using bulky additives that prevent horizontal orientation of particles 120 upon their deposition. Alternative or complementary ways of controlling the orientation of particles 120 comprise fast deposition and/or casting of respective layer 105 to limit aligning of particles 120; shape and/or size control of polymer aggregates in the casting dispersion, electromagnetically aligning particles 120 in a desired direction, etc.

In various embodiments, separation layer(s) 105 may comprise a self-assembled LDH formed, e.g., by deposition of exfoliated LDH nanoparticles. In some embodiments, LDH inorganic nano-filler may be either provided or synthesized, and optionally of exfoliated and/or modified by ion-exchanging, solvent intercalation and surfactant intercalation. Exfoliation may be carried out by swelling in a solvent, by low shear mixing, by high shear mixing, by sonication and/or by combinations thereof, leading to the formation of the self-assembled LDH membrane.

In various embodiments, the self-assembled LDH membrane embedded in polymer to form separation layer 105 and/or be attached as separation layer 105 to and/or be deposited upon any of the other layers of membrane assembly 100, e.g., anode catalyst layer 130 and/or cathode catalyst layer 140—to form respective catalyst coated membrane(s) and optionally on cathode-side gas diffusion layer(s) (GDLs) 135 and/or on anode-side gas diffusion layer(s) (GDLs) 145 and/or on respective cathode-side gas diffusion electrode(s) (GDEs) 135 and/or on anode-side gas diffusion electrode(s) (GDEs) 145.

In various embodiments, LDH may be synthesized using wet chemistry process(es) conducted in aqueous solution comprising, e.g., mixture(s) of divalent and/or trivalent metal salts, e.g., Mg(NO₃)₂·6H₂O (divalent), and Al(NO₃)₃·9H₂O (trivalent). The salts may be reacted with alkaline solution, like a mixture of NaOH and Na₂CO₃, under a pH ranging from 4 to 12, and under vigorous stirring, either with or without heating.

LDH-based separation layer(s) 105 may be prepared by deposition on a substrate of a dispersion including a liquid matrix of optionally neutral polymer and anion conducting nanoparticles such as LDH. Deposition methods and substrates may comprise any of those disclosed herein. In certain embodiments, fabrication of LDH-based separation layer(s) 105 may be carried out using vacuum-assisted process(es), e.g., by deposition on top of a nano-porous ultra-flat substrate, such as a ceramic filter (e.g., anodic alumina). Liquid solvent removal may be utilized to induce the self-assembly of the LDH nano-platelets into a thin and self-supported membrane. In some embodiments, the dispersion may include a mixture of pre-synthesized LDH nanoparticles and a neutral polymer precursor. In some embodiments, the dispersion may include a mixture of pre-synthesized LDH nanoparticles and a mixture of neutral monomers and/or oligomers to be polymerized. In some embodiments, the dispersion may include a neutral polymer precursor and components, for example, metallic salts and alkaline solution to serve as precursors for forming in-situ synthesis of the LDH nanoparticles. In some embodiments, the dispersion may comprise crosslinking agents, and may be hardened, e.g., by drying, curing, UV curing, etc.

In various embodiments, particles 120 may be dispersed within matrix 110 at various concentrations (e.g., low solids content, e.g., between 1-30 weight %, medium solids content, e.g., between 30-60 weight % or high solids content, e.g., between 60-100 weight %). In certain embodiments, at least some, most, or practically all particles 120 may contact each other within matrix 110. Clearly, in different separation layer(s) 105 the sizes, the concentration and/or the dispersion of particles 120 may be different.

At least some of separation layer(s) 105 may be configured to have particles 120 (e.g., LDH particles) contacting each other to form anion conducting path(s) through separation layer(s) 105. LDH particles 120 may have lateral dimensions ranging from a few tens of nm to a few microns. The lateral dimensions of particles 120 may be monodisperse, polydisperse or multi-modal. The cross-sectional thickness of particles 120 may range from about 2 nm to hundreds of nm, depending on the degree of exfoliation at the time particles 120 are dispersed and are being cast with polymer component 110 of composite layer 105. Different particle thicknesses may appear together in layer 105.

In non-limiting examples, anode catalyst layer(s) 130 may include ionomer(s) with embedded anode catalyst particles 132. In case of hydrogen fuel cells, anode catalyst particles 132 may comprise nanoparticles of any of Pt, Ir, Pd, Ru, Ni, their alloys, blends and/or combinations. In case of water electrolyzers, anode catalyst particles 132 may comprise various transition metal oxides or mixed transition metal oxides, such as oxides based on any of Ni, Fe, Pt, Ir, their alloys, blends and/or combinations.

In non-limiting examples, cathode catalyst layer(s) 140 may include ionomer(s) and cathode catalyst particles 142. In case of fuel cells, cathode catalyst particles 142 may comprise nanoparticles of any of Ag, Ag alloyed with Pt, Pd, Cu, Zr, Ag combined with metal oxides such as, e.g., cerium oxide, zirconium oxide, their alloys, blends and/or combinations. In case of electrolyzers, cathode catalyst particles 132 may comprise nanoparticles of any of Pt, Ru, Ni, Co, Fe, their alloys, blends and/or combinations.

The ionomer(s) included in anode catalyst layer 130 and cathode catalyst layer 140 may be ionomer(s) configured to conduct anions and may be different or similar in layers 130, 140. In some embodiments, ionomers of anode catalyst layer 130 and cathode catalyst layer 140 may be the same as at least one or more of ionomer(s) used for separation layer(s) 105.

Gas diffusion layer(s) (GDLs) 135 and/or 145 may include any type of gas diffusion layers such as carbon paper, non-woven carbon felt, woven carbon cloth and the like, nickel, titanium or stainless steel meshes, felts, foams, sintered microspheres, or other porous and electrically conductive substrates. In some embodiments, GDLs 135 and/or 145 may be attached to a microporous layer (MPL), made, e.g., from sintered carbon and/or optionally polytetrafluoroethylene (PTFE) or other hydrophobic particles, or from various porous metallic or other porous conductive layers.

With respect to the application of membrane assemblies 100 with separation layer(s) 105, electrolyzers 90B are typically more challenging with respect to fuel cells 90A with respect to their operating voltage (1.4V rising possibly to at least 2.0V in operation of electrolyzers 90B, versus 1.2V and decreasing during use for fuel cells 90A). This leads to the special challenge of chemically stabilizing separator 105 against oxidative decomposition at the anode interface, potentially exacerbated by the presence of active catalyst materials intended to decompose water. Meanwhile, the challenges of hydrating membrane 105 are smaller in the case of electrolyzers 90B, as is the gas handling since the gases (hydrogen and oxygen) are generated at the catalyst and need only be removed from, rather than delivered to, the catalyst surface to allow the reaction to proceed effectively. Accordingly, separation layer(s) 105 for electrolyzers 90B may be configured to achieve higher effective ionic conductivity and more effective water transport capability than separation layer(s) 105 for fuel cells 90A. By contrast, in fuel cells 90A, either interface is potentially subject to dry conditions that can exacerbate chemical degradation and/or hinder ion conductivity and water transport properties of the membrane which are dependent on its degree of hydration. Accordingly, thin protective layers 105A may be applied at both electrode interfaces.

In certain embodiments, disclosed membrane assemblies 100 and/or separation layer(s) 105 may be used as anion exchange membranes (AEM) and possibly as proton exchange membranes (PEM) for electrolyzers 90B and/or fuel cells 90A— to reduce degradation caused, e.g., by low humidity (influencing the membrane-gas interface and fluid transport) and/or high temperatures, and enhance ionic conductance and mechanical stability of the AEM/PEM by using disclosed membrane assemblies 100.

The optimization of the properties of membrane assemblies 100 with separation layer(s) 105 may be carried out with respect to the type of device 90 they are used in, and the operation conditions. For example, membrane assemblies 100 for electrolyzers 90B may be configured to minimize the rate of crossover of hydrogen and oxygen from one side of membrane assembly 100 to the other side thereof, especially the movement of hydrogen which might be electrochemically pressurized on the cathode side (140) of electrolyzer 90B, while the opposite side (anode 130) has near-atmospheric pressure. In both types of devices 90, membrane assemblies 100 may be configured to minimize the thickness of separation layer(s) 105 in order to maximize their ion conductivity and their water back-diffusion, while optimizing the thickness with respect to the resulting increased gas crossover and decreased mechanical strength, as explained above. Specifically, reinforcement of separation layer(s) 105 may be optimized with respect to the resulting reduction in ionic conductivity.

Reinforcement of membrane(s) in separation layer(s) 105 may be carried out by infusing the ionomer into inert porous matrix 110 and/or blending or cross-linking ionomer matrix 110 with other matrix materials which are less (or not) ion-conductive, but have better mechanical properties than ionomer matrix 110, as disclosed herein. In various embodiments, ionomeric matrix 110 may be mixed with inorganic strengthening particles 120 such as various clays, as disclosed herein, resulting in thinner membranes which are still mechanically strong and resistant to gas crossover. Specifically when particles 120 are ion-conductive (e.g., charged ceramic particles or surface-charged particles), they may at least partly compensate for the reduced ion conductivity or even enhance the ionic conductivity of separation layer(s) 105. Particles 120 may be selected to be more resistant to chemical decomposition than matrix 110 and accordingly allow higher operation temperatures, leading to increased efficiency of devices 90. For example, disclosed membrane assemblies 100 may be configured to be operable at high temperatures, e.g., well over 80° C. and possibly as high as 120° C., 140° C. or higher, possibly limited only by the ability to maintain hydration by maintaining water below its boiling point via elevated pressure, salt concentration or other means.

FIGS. 3A and 3B provide a non-limiting example for membrane stability over time, according to some embodiments of the invention. Separation layer 105 included a 45 μm thick membrane made of LDH particles 120 bonded by a polyallylamine binder as matrix 100 at 87%-13% weight ratio. Disclosed membranes may be used as a free-standing separation layer 105 as per FIG. 2A, in which case a 5-100 micron thick membrane maybe appropriate, depending on the specific device and target application in fuel cell 90A or electrolyzer 90B. Alternatively, disclosed membranes may be applied as intermediate layer(s) in devices illustrated, e.g., in FIG. 2B or 2C, in which case the membrane would normally be made very thin (<<10 microns) partnering with another layer or layers 105B to achieve the overall separator function. FIG. 3A illustrates the stable through-plane ion conductivity of separation layer 105 over more than 20 hours at an operation temperature of 120° C. and 95% relative humidity (RH), and FIG. 3B illustrates the stable through-plane ion conductivity of separation layer 105 over more than 120 hours at an operation temperature of 95° C. and at 95% RH.

In the non-limiting example, thin protective layer 105A with 87 weight % LDH particles 120 was fabricated using exfoliated LDH with 2:1 Mg:Al metal atom ratio and nitrate/OH− counterions, in water to yield a dispersion of nanosheets illustrated, e.g., in FIGS. 3E and 3F. Specifically, solution of Polyallylamine (5 wt %) in hydrochloride form was added to a dispersion of exfoliated nitrate LDH (5 wt %) to yield a mixture comprising LDH and polymer at a ratio of 83:17% wt/wt. 1.0 g of the obtained dispersion of LDH nanoplates in poly(allylamine) solution was then cast onto a polystyrene plate and the solvent (water) evaporated at 60° C. overnight, yielding a polymer/inorganic composite film on the plate. The film was peeled off by hand from the plate and the film conductivity was measured yielding the results shown in FIGS. 3A and 3B.

FIG. 3C provides a non-limiting example for the advantageous decrease in hydrogen crossover for anion exchange membranes protected by a thin LDH layer, according to some embodiments of the invention. The examples compared prior art unprotected membranes with separation layer 105 comprising protective, high solids content layers 105A, 105C (of FIG. 2B), 105E and ionomer membrane 105B (and 105D in FIG. 2C), as illustrated schematically, e.g., in FIGS. 2B-2D and shown in the SEM images of FIG. 4. The results show that incorporating 3 μm-thin LDH layers 105A, 105C as protective layers reduced the rate of hydrogen crossover, reflected in the reduction of the limiting current from 2.42 mA/cm² to 1.90 mA/cm², as explained below. Separation layer 105 with two-sided protection by protective layers 105A, 105C (see, e.g., FIG. 2B) was formed from ionomeric anion exchange membrane 105B in carbonate form that was fixed to a temperature-controlled vacuum table held at 65° C. The protective layers were fabricated by loading 0.2 ml of a dispersion of LDH (1% ww exfoliated, Mg:Al 2:1 LDH with OH− counterions) in water into an airbrush and sprayed evenly onto the surface of membrane 105B to form layer 105A. The surface was allowed to dry and the coated membrane was then separated from the vacuum table and re-affixed with the opposite side facing outwards. An equal amount of the LDH solution was applied to the opposite side of the membrane in identical fashion to form layer 105C. Resulting coatings 105A, 105C were made of 100% LDH and approximately 3 microns thick on each side of membrane 105B.

Hydrogen crossover was measured by ion-exchanging membrane layer 105B to OH− form by soaking it in 1M NaOH, washing and assembling the membrane into fuel cell hardware of 5 cm² active area, together with Pt/Carbon gas-diffusion electrodes (0.5 mg/cm² Pt loading and 20% w/w of anion exchange ionomer on a wet-proofed carbon cloth with microporous layer). The hardware was electrically connected to a potentiostat and humidified hydrogen gas introduced to the counter-electrode side of the fuel cell hardware, held at 3 bar(g) (gauge pressure in bars above ambient pressure) with a continuous low flow rate. Humidified nitrogen gas was introduced to the working electrode, held at 1 bar(g) and the same flow rate, thereby applying 2 bar of positive pressure differential between the hydrogen and nitrogen sides. Some hydrogen crossover from hydrogen to nitrogen sides thus occurs, and an open circuit potential of a few tens of mV is measured due to the hydrogen concentration difference between counter and working electrodes.

A variable positive potential in the range of 0-1.0 V was applied between counter- and working electrodes so that the counter-electrode underwent cathodic hydrogen evolution, and the working electrode, held under nitrogen, caused a hydrogen oxidation reaction using as a reactant the hydrogen crossing over from the counter-electrode side. As the potential was increased, the measured current increased up to a limiting current, indicated by the plateau values in the I-V plot in FIG. 3C. This current represents the rate of hydrogen crossover from the counter-electrode side into the working electrode, via the membrane, and is directly determined by, and proportional to, the rate of hydrogen crossover. As indicated in FIG. 3C, hydrogen crossover is significantly higher through separation layer 105 that includes protective layer 105A than through a regular membrane without the protective layer.

FIG. 3D provides a non-limiting example for the relation between the conductivity and the operation temperature of separation layer 105 with high LDH solids content, according to some embodiments of the invention. Specifically, separation layer 105 in the example was made of 83 weight % Mg—Al LDH particles 120 in anion-conducting cross-linked QPVA (glutaraldehyde-crosslinked quaternized poly(vinyl alcohol)) membrane matrix 110, and conductivity was measured in-plane at 98% RH, as disclosed in the following. QPVA was prepared by grafting a quaternary ammonium functional group onto poly(vinyl alcohol). A dispersion in deionized water of exfoliated LDH (4.5 wt % with OH− counterion) of composition 2:1 Mg:Al, was titrated with dilute nitric acid from its initial pH of 10.5 to pH 7.7, leaving the LDH counterions substantially in nitrate form. 0.45 g of an aqueous solution of QPVA (5% w/w) was added to 2.8 g of this dispersion. 0.26 g of an aqueous solution (1% w/w) of glutaraldehyde (GA), was added to give a total ratio of 83% LDH/17% organics (QPVA+GA). The mixture was placed in a glass Petri dish (6 cm diameter), and held at 60° C. overnight, after which the crosslinked, LDH-loaded membrane film of thickness ca. 40 micron was formed on the substrate.

The formed membrane was then removed from the substrate by soaking in dilute aqueous KOH, and immersed in aqueous sodium nitrate (3.5M) for 36 hours at 60° C., washed three times with deionized water, and placed in a Scribner Associates Membrane Test System (MTS) equipped with temperature and relative humidity control up to 120° C. The conductivity of the membrane was measured at 98% relative humidity, at temperatures ranging from 40-120° C., yielding high conductivity, increasing with temperature as shown in FIG. 3D.

FIGS. 3E and 3F provide illustrations of shapes and size distributions of LDH particles 120 used to form separation layers 105, according to some embodiments of the invention. FIG. 3E includes a cryo-TEM (transmission electron microscopy) image of exfoliated Mg—Al LDH particles 120 with chloride counterions, dispersed in water. The image shows thin hexagonal particles 120, some of which seen in through-plane orientation as hexagonal shapes ranging from tens to about 100 nm across, while others are oriented in a cross-sectional direction, showing stripes of tens of nm length and a few nanometers thick. The thickness in the cross-sectionally oriented particles corresponds to short stacks of a few crystalline nanosheets. Dynamic light scattering measurements of the chloride-LDH dispersion showed a main particle size range of average 68 nm hydrodynamic radius, as illustrated in the respective graph and in good agreement with the cryo-TEM image. The XRD (X-ray diffraction) graph indicates that the hydrotalcite crystal structure has a crystallite size of 44 Å by Scherrer analysis, and unit cell sizes a,c of 3.0 Å and 29.0 Å, respectively. FIG. 3F is a cryo-TEM image of exfoliated Mg—Al LDH particles 120 with nitrate counterions, dispersed in water. The dynamic light scattering measurements of the nitrate-LDH dispersion shows a main particle size range of average 70 nm hydrodynamic radius, as illustrated in the respective graph and in good agreement with the cryo-TEM image. The XRD graph indicates that the hydrotalcite crystal structure has a crystallite size of 27 Å by Scherrer analysis, and unit cell sizes a,c of 3.0 Å and 27.7 Å, respectively.

FIG. 4 provide low- and high-resolution SEM (scanning electron microscope) images of a cross section of membrane 105B coated by protective layer 105A and of the surface of the protective layer, according to some embodiments of the invention. The membrane comprises ionomeric layer 105B having a thickness of ca. 13 μm, while protective layer 105A is ca. 3 μm thick and comprises a film of 2:1 Mg:Al LDH nanoplatelets 120, which are individually visible in the magnified high resolution image. Another high-resolution magnified image clearly shows the layered structure of agglomerated platelets 120 that constitute protective layer 105A.

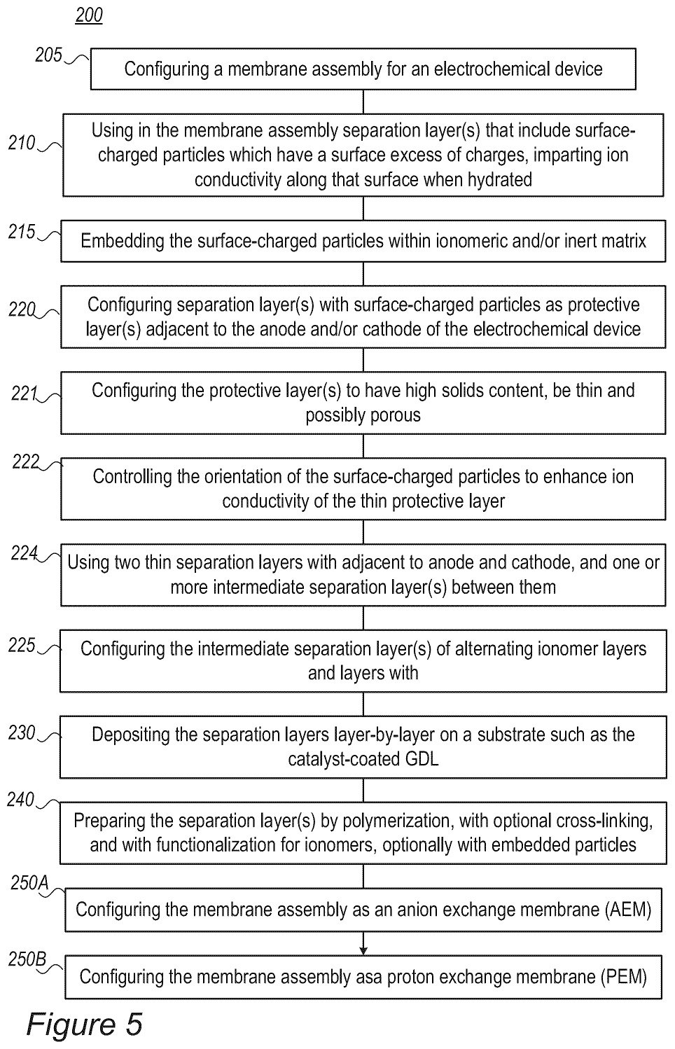

FIG. 5 is a high-level flowchart illustrating a method 200, according to some embodiments of the invention. The method stages may be carried out to produce membrane assemblies 100 and/or separation layer(s) 105 described above, method 200 may comprise the following stages, irrespective of their order.

Method 200 may comprise configuring a membrane assembly for an electrochemical device (stage 205), comprising, e.g., using in the membrane assembly at least one separation layer that includes surface-charged particles (such as charged ceramic particles) which have a surface excess of charges, imparting ion conductivity along that surface when hydrated (stage 210). For example, method 200 may comprise embedding the surface-charged particles and/or charged ceramic particles within ionomeric and/or inert matrix, e.g., as part of any of the precursors before polymerization, during polymerization, or possibly upon completion of polymerization.

Method 200 may comprise configuring at least one of the separation layers having the charged ceramic particles and/or surface-charged particles as respective at least one protective layer, adjacent to an anode and/or to a cathode of the electrochemical device (stage 220). In certain embodiments, method 200 may further comprise configuring the protective layer(s) to have high solids content (e.g., above 70, 80, 90 weight % or even approaching 100 weight %), be thin (e.g., less than 10 μm thick or less than 5 μm thick, or possibly even under 1 μm) and possibly porous (stage 221). In certain embodiments, e.g., using evaporating solvent(s), the thickness of layer(s) with high solids content of the charged ceramic particles and/or surface-charged particles may be reduced to few hundreds of nm, few tens of nm, or even few nm. In certain embodiments, method 200 may further comprise controlling the orientation of the charged ceramic particles (or other surface-charged particles) to enhance ion conductivity (stage 222), e.g., using the deposition method, external forces and/or additives to cause at least some of the charged particles to deviate from the orientation of their respective, e.g., at small to large angles, e.g., one or few 10° and up to 80-90°—yielding charged particles that are perpendicular to the layer to enhance its ion conductivity.

Method 200 may further comprise using two thin protective separation layers with surface-charged particles (such as charged ceramic particles) adjacent to the anode and the cathode, and one or more intermediate separation layer(s) between them (stage 224), e.g., by configuring the at least one separation layer to comprise at least two protective separation layers with surface-charged particles (such as charged ceramic particles) that are less than 10 μm thick and are adjacent to the anode and to the cathode of the electrochemical device, and at least one intermediate ionomeric separation layer between the at least two separation layers with charged ceramic particles and/or surface-charged particles. In certain embodiments, method 200 may comprise configuring the intermediate separation layer(s) of alternating ionomer layers and layers with charged ceramic particles and/or surface-charged particles (stage 225), e.g., by configuring the at least two separation layers with charged ceramic particles (and/or surface-charged particles) to comprise at least three layers, the at least one ionomeric separation layer comprises at least two ionomeric separation layer that have a thickness smaller than 20 μm and are separated by at least one separation layers with the charged ceramic particles and/or surface-charged particles.

Method 200 may further comprise depositing the at least one separation layer layer-by-layer on a substrate comprising at least one catalyst-coated GDL (stage 230). Any of the chemical reactions of polymerization, cross-linking and/or functionalization may be carried out before, during or after deposition, as operatively applicable. Method 200 may accordingly comprise preparing the separation layer(s) by polymerization, with optional cross-linking, and with functionalization for ionomers, optionally with embedded particles.

In various embodiments, method 200 may comprise configuring the membrane assembly as an anion exchange membrane (AEM) of a respective AEM electrochemical device comprising a fuel cell or an electrolyzer (stage 250A), or alternatively, in various embodiments, method 200 may comprise configuring the membrane assembly as a proton exchange membrane (PEM) of a respective PEM electrochemical device comprising a fuel cell or an electrolyzer (stage 250B).

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A membrane assembly for an electrochemical device, the membrane assembly comprising at least one separation layer that includes surface-charged particles,
wherein the surface-charged particles have a surface excess of charges, imparting ion conductivity along that surface when hydrated.

2. The membrane assembly of claim 1, wherein the surface-charged particles comprise at least one of charged clay particles, charged ceramic particles, graphene oxide particles, reduced or partially reduced graphene oxide particles and surface-charged polymer particles,
wherein optionally the surface-charged particles are embedded within ionomeric and/or inert matrix.

3. The membrane assembly of claim 1, wherein (i) the at least one separation layer comprises one separation layer that includes surface-charged particles and has a thickness of at least 30 μm, or
wherein the at least one separation layer comprises at least two separation layers, comprising at least one separation layer that includes surface-charged particles and has a thickness of at least 5 μm.

4. The membrane assembly of claim 1, wherein the at least one separation layer comprises:
at least one ionomeric separation layer, and
at least one separation layer with surface-charged particles, configured as a protective layer to protect the at least one ionomeric separation layer, set adjacent to an anode and/or a cathode of the electrochemical device, and being less than 10 μm thick or less than 5 μm thick.

5. The membrane assembly of claim 4, comprising two separation layers with surface-charged particles, set as protective layers on both sides of the at least one ionomeric separation layer, and each being less than 10 μm thick or less than 5 μm thick, and
wherein the at least one ionomeric separation layer comprises two ionomeric separation layers with an intermediate separation layer with surface-charged particles, wherein each of the two ionomeric separation layers is less than 20 μm thick and the intermediate separation layer with surface-charged particles is less than 10 μm thick or less than 5 μm thick.

6. The membrane assembly of claim 1, wherein a weight % of surface-charged particles in the respective separation layers with surface-charged particles is at least 60% and the respective separation layer is thinner than 1 μm.

7. The membrane assembly of claim 1, wherein at least some of the surface-charged particles are set at an angle with respect to the respective separation layer to enhance its ion conductivity.

8. The membrane assembly of claim 1, wherein the surface-charged particles have a surface excess of positive charges, imparting anion conductivity along that surface when hydrated.

9. The membrane assembly of claim 8, wherein the surface-charged particles include charged ceramic particles, optionally LDH.

10. The membrane assembly of claim 8, configured as an anion exchange membrane (AEM) of a respective AEM electrochemical device comprising a fuel cell or an electrolyzer.

11. The membrane assembly of claim 1, wherein the surface-charged particles have a surface excess of negative charges, imparting cation conductivity along that surface when hydrated, and further
configured as a proton exchange membrane (PEM) of a respective PEM electrochemical device comprising a fuel cell or an electrolyzer.

12. A membrane assembly for an electrochemical device, the membrane assembly comprising:
at least one ionomeric separation layer having a total thickness larger than 1 μm, and
at least one protective layer comprising nanoparticles, set adjacent to an anode and/or a cathode of the electrochemical device, and being less than 10 μm thick or less than 5 μm thick,
wherein the at least one protective layer is configured to separate the at least one ionomeric separation layer from respective anode and/or cathode, and has an ion-conductivity that is smaller than 10 mS/cm.

13. The membrane assembly of claim 12, wherein the at least one protective layer has an ion-conductivity that is smaller than 1 mS/cm.

14. The membrane assembly of claim 13, wherein the at least one protective layer is partial or porous.

15. The membrane assembly of claim 14, wherein the at least one protective layer has an ion-conductivity that is smaller than 0.01 mS/cm at its continuous or non-porous parts, respectively.

16. A method of configuring a membrane assembly for an electrochemical device, the method comprising using in the membrane assembly at least one separation layer that includes surface-charged particles which have a surface excess of charges, imparting ion conductivity along that surface when hydrated, optionally
further comprising embedding the surface-charged particles within an ionomeric and/or inert matrix.

17. The method of claim 16, further comprising configuring at least one of the separation layers having the surface-charged particles as respective at least one protective layer, adjacent to an anode and/or to a cathode of the electrochemical device, being less than 10 μm thick or less than 5 μm thick.

18. The method of claim 16, further comprising controlling the orientation of the surface-charged particles to enhance ion conductivity.

19. The method of claim 16, further comprising depositing the at least one separation layer layer-by-layer on a substrate comprising at least one catalyst-coated GDL.

20. The method of claim 16, further comprising (i) configuring the membrane assembly as an anion exchange membrane (AEM) of a respective AEM electrochemical device comprising a fuel cell or an electrolyzer, or (ii)
configuring the membrane assembly as a proton exchange membrane (PEM) of a respective PEM electrochemical device comprising a fuel cell or an electrolyzer.
